(19) United States
(12) Patent Application Publication
(10) Pub. No.: US 2019/0386787 A1
(43) Pub. Date: Dec. 19, 2019

(54) METHOD AND APPARATUS FOR HANDLING DIFFERENT SHORT TRANSMISSION TIME INTERVALS IN WIRELESS COMMUNICATION SYSTEM

(71) Applicant: LG Electronics Inc., Seoul (KR)

(72) Inventors: Yunjung Yi, Seoul (KR); Hyunho Lee, Seoul (KR); Daesung Hwang, Seoul (KR)

(21) Appl. No.: 16/484,846

(22) PCT Filed: Feb. 14, 2018
(86) PCT No.: PCT/KR2018/001927

§ 371 Date: Aug. 9, 2019

Related U.S. Application Data
(60) Provisional application No. 62/458,583, filed on Feb. 14, 2017.

(51) Int. Cl. H04L 1/18; H04L 5/00; H04L 1/16; H04W 72/12

(52) U.S. Cl. CPC H04L 1/1854; H04L 5/0055; H04W 88/02; H04L 5/0094; H04W 72/1278; H04L 1/1671

(57) ABSTRACT

As an aspect of handling different short transmission time intervals (TTIs) configured dynamically, the present invention provides a method and apparatus for transmitting an acknowledgement/non-acknowledgement (ACK/NACK) signal by a user equipment (UE) in a wireless communication system. The UE receives, from a network, a configuration of multiple short TTIs, receives, from the network, a total downlink assignment index (DAI) per each short TTI separately, and transmits, to the network, a bundled ACK/NACK signal for the multiple short TTIs according to the total DAI per each short TTI.

### CROSS-REFERENCE TO RELATED APPLICATIONS

This application is the National Stage filing under 35 U.S.C. 371 of International Application No. PCT/KR2018/001927, filed on Feb. 14, 2018, which claims the benefit of U.S. Provisional Application No. 62/458,583 filed on Feb. 14, 2017, the contents of which are all hereby incorporated by reference herein in their entirety.

### BACKGROUND OF THE INVENTION

### Field of the Invention

The present invention relates to wireless communications, and more particularly, to a method and apparatus for handling different short transmission time intervals (TTIs) configured dynamically in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultra-reliable and low latency communication (URLLC) is discussed. This new technology may be called new radio access technology (new RAT or NR) for convenience.

In NR, analog beamforming may be introduced. In case of millimeter wave (mmW), the wavelength is shortened so that a plurality of antennas can be installed in the same area. For example, in the 30 GHz band, a total of 100 antenna elements can be installed in a 2-dimension array of 0.5 lambda (wavelength) intervals on a panel of 5 by 5 cm with a wavelength of 1 cm. Therefore, in mmW, multiple antenna elements can be used to increase the beamforming gain to increase the coverage or increase the throughput.

In this case, if a transceiver unit (TXRU) is provided so that transmission power and phase can be adjusted for each antenna element, independent beamforming is possible for each frequency resource. However, installing a TXRU on all 100 antenna elements has a problem in terms of cost effectiveness. Therefore, a method of mapping a plurality of antenna elements to one TXRU and adjusting the direction of a beam using an analog phase shifter is considered. This analog beamforming method has a disadvantage that it cannot perform frequency selective beaming because it can make only one beam direction in all bands.

A hybrid beamforming with B TXRUs, which is an intermediate form of digital beamforming and analog beamforming, and fewer than Q antenna elements, can be considered. In this case, although there is a difference depending on the connection method of the B TXRU and Q antenna elements, the direction of the beam that can be simultaneously transmitted is limited to B or less.

For operating NR efficiently, various schemes have been discussed.

### SUMMARY OF THE INVENTION

The present invention provides a method and apparatus for handling different short transmission time intervals (TTIs) configured dynamically in a wireless communication system. The present invention presents mechanisms to handle variable sizes of sTTI particularly for uplink transmission. The present invention also discusses mechanisms to handle different sTTI length for initial and retransmission.

In an aspect, a method for transmitting an acknowledgement/non-acknowledgement (ACK/NACK) signal by a user equipment (UE) in a wireless communication system is provided. The method includes receiving, by the UE from a network, a configuration of multiple short transmission time intervals (TTIs), receiving, by the UE from the network, a total downlink assignment index (DAI) per each short TTI separately, and transmitting, by the UE to the network, a bundled ACK/NACK signal for the multiple short TTIs according to the total DAI per each short TTI.

In another aspect, a user equipment (UE) in a wireless communication system is provided. The UE includes a memory, a transceiver, and a processor, operably coupled to the memory and the transceiver, that controls the transceiver to receive, from a network, a configuration of multiple short transmission time intervals (TTIs), controls the transceiver to receive, from the network, a total downlink assignment index (DAI) per each short TTI separately, and controls the transceiver to transmit, to the network, a bundled acknowledgement/non-acknowledgement (ACK/NACK) signal for the multiple short TTIs according to the total DAI per each short TTI.

Different sizes of short TTIs can be handled efficiently.

### BRIEF DESCRIPTION OF THE DRAWINGS

FIG. 1 shows a 3GPP LTE system.

FIG. 2 shows structure of a radio frame of 3GPP LTE.

FIG. 3 shows a resource grid for one downlink slot.

FIG. 4 shows an example of subframe type for NR.

FIG. 5 shows an example of configuring sTTI length for DL and/or UL according to an embodiment of the present invention.

FIG. 6 shows a method for transmitting an ACK/NACK signal by a UE according to an embodiment of the present invention.

FIG. 7 shows a wireless communication system to implement an embodiment of the present invention.

### DESCRIPTION OF EXEMPLARY EMBODIMENTS

The following description will focus on 3rd generation partnership project (3GPP) long-term evolution (LTE) advanced (LTE-A). However, technical features of the present invention are not limited thereto, and may be applied to other various technologies, e.g. a new radio access technology (new RAT or NR).

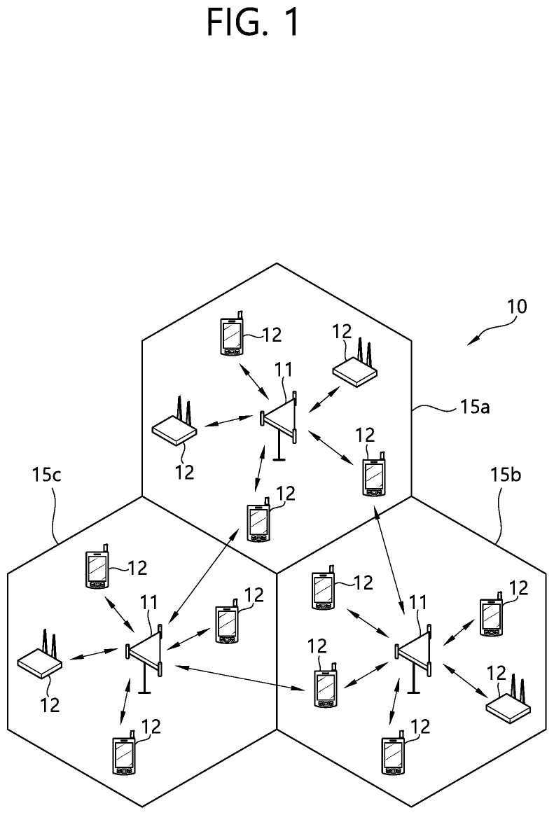

FIG. 1 shows a 3GPP LTE system. The 3rd generation partnership project (3GPP) long-term evolution (LTE) system 10 includes at least one eNodeB (eNB) 11. Respective eNBs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile terminal (MT), user terminal (UT), subscriber station (SS), wireless device, personal digital assistant (PDA), wireless modem, handheld device. The eNB 11 generally refers to a fixed station that communicates with the UE 12 and may be called by other names such as base station (BS), base transceiver system (BTS), access point (AP), etc.

In general, a UE belongs to one cell, and the cell to which a UE belongs is called a serving cell. An eNB providing a communication service to the serving cell is called a serving eNB. The wireless communication system is a cellular system, so a different cell adjacent to the serving cell exists. The different cell adjacent to the serving cell is called a neighbor cell. An eNB providing a communication service to the neighbor cell is called a neighbor eNB. The serving cell and the neighbor cell are relatively determined based on a UE.

This technique can be used for DL or UL. In general, DL refers to communication from the eNB 11 to the UE 12, and UL refers to communication from the UE 12 to the eNB 11. In DL, a transmitter may be part of the eNB 11 and a receiver may be part of the UE 12. In UL, a transmitter may be part of the UE 12 and a receiver may be part of the eNB 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

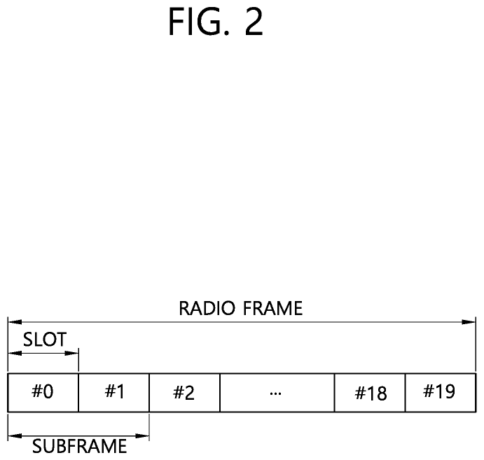

FIG. 2 shows structure of a radio frame of 3GPP LTE. Referring to FIG. 2, a radio frame includes 10 subframes. A subframe includes two slots in time domain. A time for transmitting one transport block by higher layer to physical layer (generally over one subframe) is defined as a transmission time interval (TTI). For example, one subframe may have a length of 1 ms, and one slot may have a length of 0.5 ms. One slot includes a plurality of orthogonal frequency division multiplexing (OFDM) symbols in time domain. Since the 3GPP LTE uses the OFDMA in the DL, the OFDM symbol is for representing one symbol period. The OFDM symbols may be called by other names depending on a multiple-access scheme. For example, when SC-FDMA is in use as a UL multi-access scheme, the OFDM symbols may be called SC-FDMA symbols. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

The wireless communication system may be divided into a frequency division duplex (FDD) scheme and a time division duplex (TDD) scheme. According to the FDD scheme, UL transmission and DL transmission are made at different frequency bands. According to the TDD scheme, UL transmission and DL transmission are made during different periods of time at the same frequency band. A channel response of the TDD scheme is substantially reciprocal. This means that a DL channel response and a UL channel response are almost the same in a given frequency band. Thus, the TDD-based wireless communication system is advantageous in that the DL channel response can be obtained from the UL channel response. In the TDD scheme, the entire frequency band is time-divided for UL and DL transmissions, so a DL transmission by the eNB and a UL transmission by the UE cannot be simultaneously performed. In a TDD system in which a UL transmission and a DL transmission are discriminated in units of subframes, the UL transmission and the DL transmission are performed in different subframes. In a TDD system, to allow fast switching between DL and UL, UL and DL transmission may be performed within a same subframe/slot in time division multiplexing (TDM)/frequency division multiplexing (FDM) manner.

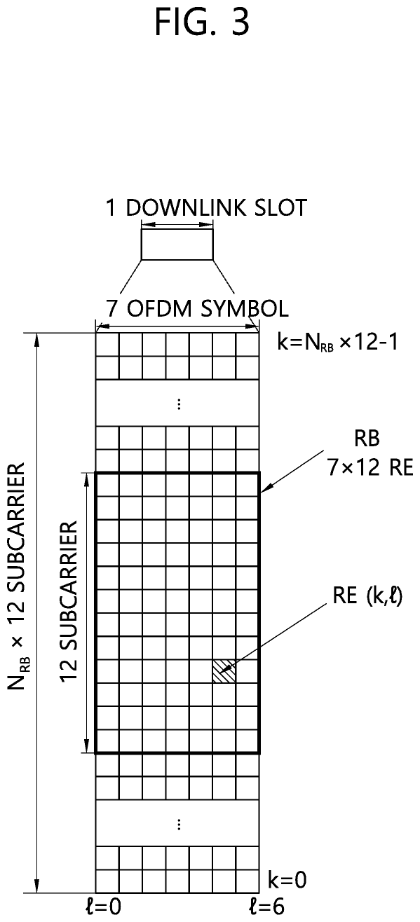

FIG. 3 shows a resource grid for one downlink slot. Referring to FIG. 3, a DL slot includes a plurality of OFDM symbols in time domain. It is described herein that one DL slot includes 7 OFDM symbols, and one RB includes 12 subcarriers in frequency domain as an example. However, the present invention is not limited thereto. Each element on the resource grid is referred to as a resource element (RE). One RB includes 12×7 or 12×14 resource elements. The number N_{DL} of RBs included in the DL slot depends on a DL transmit bandwidth. The structure of a UL slot may be same as that of the DL slot. The number of OFDM symbols and the number of subcarriers may vary depending on the length of a CP, frequency spacing, etc. For example, in case of a normal cyclic prefix (CP), the number of OFDM symbols is 7 or 14, and in case of an extended CP, the number of OFDM symbols is 6 or 12. One of 128, 256, 512, 1024, 1536, 2048, 4096 and 8192 may be selectively used as the number of subcarriers in one OFDM symbol.

Downlink assignment index (DAI) in described. DAI may be present in downlink control information (DCI) format. DAI may be present in the DCI format only for cases with TDD primary cell and either TDD operation with UL-DL configurations 1-6 or FDD operation. The number of bits for DAI may be as follows in Table 1.

TABLE 1

| Number of bits | |
|---|---|
| 4 | For UEs configured by higher layers with codebooksizeDetermination-r13 = |
| | dai and when a DCI format scheduling physical downlink shared channel |
| | (PDSCH) is mapped onto the UE specific search space given by the cell radio |
| | network temporary identity (C-RNTI), the 4-bit DAI consists of a 2-bit counter |
| | DAI and a 2-bit total DAI. |
| 2 | For UEs configured with no more than five DL cells, or for UEs configured by |
| | higher layers with codebooksizeDetermination-r13 = cc, or for UEs configured |
| | by higher layers with codebooksizeDetermination-r13 = dai and when a DCI |
| | format scheduling PDSCH is not mapped onto the UE specific search space |
| | given by the C-RNTI, this field is present for FDD or TDD operation, for cases |
| | with TDD primary cell. If the UL/DL configuration of all TDD serving cells is |
| | same and the UE is not configured to decode physical downlink control |
| | channel (PDCCH) with cyclic redundancy check (CRC) scrambled by eimta- |
| | RNTI, then this field only applies to serving cell with UL/DL configuration 1-6. |
| | If at least two TDD serving cells have different UL/DL configurations or the |
| | UE is configured to decode PDCCH with CRC scrambled by eimta-RNTI, then |
| | this field applies to a serving cell with DL-reference UL/DL configuration 1-6. |
| 0 | For UEs configured with no more than five DL cells, or for UEs configured by |
| | higher layers with codebooksizeDetermination-r13 = cc, or for UEs configured |
| | by higher layers with codebooksizeDetermination-r13 = dai and when a DCI |
| | format scheduling PDSCH is not mapped onto the UE specific search space |
| | given by the C-RNTI, this field is not present for FDD or TDD operation, for |
| | cases with FDD primary cell. |

For FDD hybrid automatic repeat request (HARQ)-acknowledgement (ACK) reporting procedure, if a UE is configured with higher layer parameter codebooksizeDetermination-r13=dai, for FDD and a subframe n, the value of the counter DAI in DCI format 1/1A/1B/1D/2/2A/2B/2C/2D denotes the accumulative number of serving cell(s) with PDSCH transmission(s) associated with PDCCH/enhanced PDCCH (EPDCCH) and serving cell with PDCCH/EPDCCH indicating DL semi-persistent scheduling (SPS) release, up to the present serving cell in increasing order of serving cell index. The value of the total DAI in DCI format 1/1A/1B/1D/2/2A/2B/2C/2D denotes the total number of serving cell(s) with PDSCH transmission(s) associated with PDCCH/EPDCCH(s) and serving cell with PDCCH/EPDCCH indicating DL SPS release. Denote V_{C-DAI,c}^{DL} as the value of the counter DAI in DCI format 1/1A/1B/1D/2/2A/2B/2C/2D scheduling PDSCH transmission or indicating DL SPS release for serving cell c, according to Table 2 below. Denote V_{T-DAI}^{DL} as the value of the total DAI, according to Table 2. The UE shall assume a same value of total DAI in all PDCCH/EPDCCH scheduling PDSCH transmission(s) and PDCCH/EPDCCH indicating DL SPS release in a subframe.

TABLE 2

| DAI | | Number of serving cells with PDSCH transmission |
|---|---|---|
| MSB, | V_{C-DAI, c}^{DL} | associated with PDCCH/EPDCCH and serving cell |
| LSB | or V_{T-DAI}^{DL} | with PDCCH/EPDCCH indicating DL SPS release |
| 0, 0 | 1 | 1 or 5 or 9 or 13 or 17 or 21 or 25 or 29 |
| 0, 1 | 2 | 2 or 6 or 10 or 14 or 18 or 22 or 26 or 30 |
| 1, 0 | 3 | 3 or 7 or 11 or 15 or 19 or 23 or 27 or 31 |
| 1, 1 | 4 | 0 or 4 or 8 or 12 or 16 or 20 or 24 or 28 or 32 |

For TDD HARQ-ACK reporting procedure for same UL/DL configuration, if a UE is configured with higher layer parameter codebooksizeDetermination-r13=dai, the value of the counter DAI in DCI format 1/1A/1B/1D/2/2A/2B/2C/2D denotes the accumulative number of {serving cell, subframe}-pair(s) in which PDSCH transmission(s) associated with PDCCH/EPDCCH or PDCCH/EPDCCH indicating DL SPS release is present, up to the present serving cell and present subframe, first in increasing order of serving cell index and then in increasing order of subframe index within subframe(s)n-k where k∈K. The value of the total DAI in DCI format 1/1A/1B/1D/2/2A/2B/2C/2D denotes the total number of {serving cell, subframe}-pair(s) in which PDSCH transmission(s) associated with PDCCH/EPDCCH(s) or PDCCH/EPDCCH indicating DL SPS release is present, up to the present subframe within subframe(s)-k where k∈K, and shall be updated from subframe to subframe. Denote V_{C-DAIc,k}^{DL} as the value of the counter DAI in DCI format 1/1A/1B/1D/2/2A/2B/2C/2D scheduling PDSCH transmission or indicating DL SPS release for serving cell c in subframe n-k where k∈K according to Table 3 below. Denote V_{T-DAI,k}^{DL} as the value of the total DAI in subframe n-k where k∈K according to Table 3 below. The UE shall assume a same value of total DAI in all PDCCH/EPDCCH scheduling PDSCH transmission(s) and PDCCH/EPDCCH indicating DL SPS release in a subframe.

TABLE 3

| | | Number of {serving cell, subframe}-pair(s) in |
|---|---|---|
| | | which PDSCH transmission(s) associated with |
| DAI | | PDCCH/EPDCCH or PDCCH/EPDCCH |
| MSB, | V_{C-DAIc, k}^{DL} or | indicating downlink SPS release is present, |
| LSB | V_{T-DAI, k}^{DL} | denoted as Y and Y ≥ 1 |
| 0, 0 | 1 | mod(Y − 1, 4) + 1 = 1 |
| 0, 1 | 2 | mod(Y − 1, 4) + 1 = 2 |
| 1, 0 | 3 | mod(Y − 1, 4) + 1 = 3 |
| 1, 1 | 4 | mod(Y − 1, 4) + 1 = 4 |

For TDD HARQ-ACK reporting procedure for different UL/DL configurations, if a UE is configured with higher layer parameter codebooksizeDetermination-r13=dai, the value of the counter DAI in DCI format 1/1A/1B/1D/2/2A/2B/2C/2D denotes the accumulative number of {serving cell, subframe}-pair(s) in which PDSCH transmission(s) associated with PDCCH/EPDCCH or PDCCH/EPDCCH indicating DL SPS release is present, up to the present serving cell and present subframe, first in increasing order of serving cell index and then in increasing order of subframe index within subframe(s) n-k where k∈Y_{i∈C} Kᵢ and C is the set of configured serving cells. The value of the total DAI in DCI format 1/1A/1B/1D/2/2A/2B/2C/2D denotes the total number of {serving cell, subframe}-pair(s) in which PDSCH transmission(s) associated with PDCCH/EPDCCH(s) or PDCCH/EPDCCH indicating downlink SPS release is present, up to the present subframe within subframe(s)n-k where k∈Y_{i∈C} Kᵢ and C is the set of configured serving cells, and shall be updated from subframe to subframe. Denote V_{C-DAI,c,k}^{DL} as the value of the counter DAI in DCI format 1/1A/1B/1D/2/2A/2B/2C/2D scheduling PDSCH transmission or indicating DL SPS release for serving cell c in subframe n-k where k∈Y_{i∈C} Kᵢ according to Table 3 shown above. Denote V_{T-DAI,k}^{DL} as the value of the total DAI in subframe n-k where k∈Y_{i∈C} Kᵢ according to Table 3 shown above. The UE shall assume a same value of total DAI in all PDCCH/EPDCCH scheduling PDSCH transmission(s) and PDCCH/EPDCCH indicating DL SPS release in a subframe. For a serving cell c and a value k∈Y_{i∈C} Kᵢ but k∈/Kₑ, the {serving cell, subframe}-pair {c, n-k} is excluded when determining the values of counter DAI and total DAI for HARQ-ACK transmission in subframe n. 5th generation mobile networks or 5th generation wireless systems, abbreviated 5G, are the proposed next telecommunications standards beyond the current 4G LTE/international mobile telecommunications (IMT)-advanced standards. 5G includes both NR and LTE evolution. Hereinafter, among 5G, NR will be focused. 5G planning aims at higher capacity than current 4G LTE, allowing a higher density of mobile broadband users, and supporting device-to-device, ultra-reliable, and massive machine communications. 5G research and development also aims at lower latency than 4G equipment and lower battery consumption, for better implementation of the Internet of things.

NR may use the OFDM transmission scheme or a similar transmission scheme. NR may follow the existing LTE/LTE-A numerology, or may follow the different numerology from the existing LTE/LTE-A numerology. NR may have a larger system bandwidth (e.g. 100 MHz). Or, one cell may support multiple numerologies in NR. That is, UEs operating in different numerologies may coexist within one cell in NR.

It is expected that different frame structure may be necessary for NR. Particularly, different frame structure in which UL and DL may be present in every subframe or may change very frequently in the same carrier may be necessary for NR. Different application may require different minimum size of DL or UL portions to support different latency and coverage requirements. For example, massive machine-type communication (mMTC) for high coverage case may require relatively long DL and UL portion so that one transmission can be successfully transmitted. Furthermore, due to different requirement on synchronization and tracking accuracy requirements, different subcarrier spacing and/or different CP length may be considered. In this sense, it is necessary to consider mechanisms to allow different frame structures coexisting in the same carrier and be operated by the same cell/eNB.

In NR, utilizing a subframe in which downlink and uplink are contained may be considered. This scheme may be applied for paired spectrum and unpaired spectrum. The paired spectrum means that one carrier consists of two carriers. For example, in the paired spectrum, the one carrier may include a DL carrier and an UL carrier, which are paired with each other. In the paired spectrum, communication, such as DL, UL, device-to-device communication, and/or relay communication, may be performed by utilizing the paired spectrum. The unpaired spectrum means that that one carrier consists of only one carrier, like the current 4G LTE. In the unpaired spectrum, communication, such as DL, UL, device-to-device communication, and/or relay communication, may be performed in the unpaired spectrum.

Further, in NR, the following subframe types may be considered to support the paired spectrum and the unpaired spectrum mentioned above.

(1) Subframes including DL control and DL data

(2) Subframes including DL control, DL data, and UL control

(3) Subframes including DL control and UL data

(4) Subframes including DL control, UL data, and UL control

(5) Subframes including access signals or random access signals or other purposes.

(6) Subframes including both DL/UL and all UL signals.

However, the subframe types listed above are only exemplary, and other subframe types may also be considered.

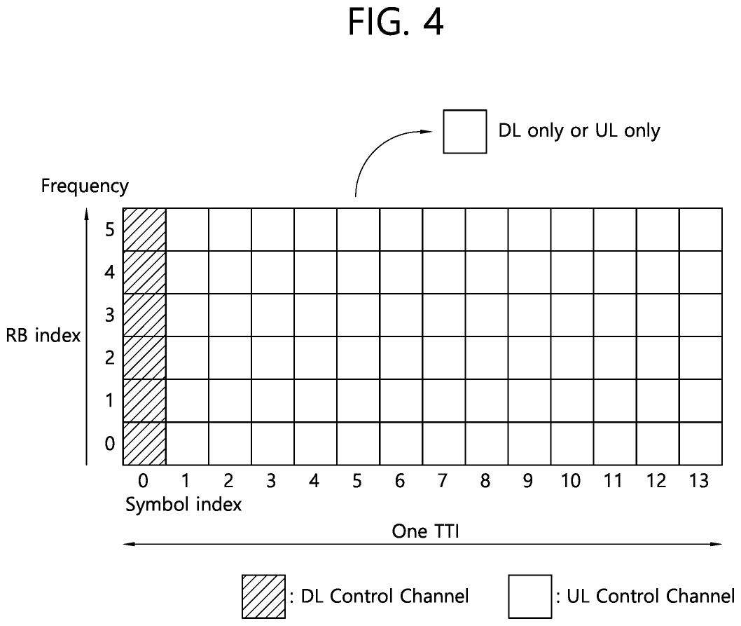

FIG. 4 shows an example of subframe type for NR. The subframe shown in FIG. 4 may be used in TDD system of NR, in order to minimize latency of data transmission. Referring to FIG. 4, the subframe contains 14 symbols in one TTI, like the current subframe. However, the subframe includes DL control channel in the first symbol, and UL control channel in the last symbol. A region for DL control channel indicates a transmission area of a physical downlink control channel (PDCCH) for Downlink control information (DCI) transmission, and a region for UL control channel indicates a transmission area of a physical uplink control channel (PUCCH) for uplink control information (UCI) transmission. Here, the control information transmitted by the eNB to the UE through the DCI may include information on the cell configuration that the UE should know, DL specific information such as DL scheduling, and UL specific information such as UL grant. Also, the control information transmitted by the UE to the eNB through the UCI may include a hybrid automatic repeat request (HARQ) acknowledgement/non-acknowledgement (ACK/NACK) report for the DL data, a channel state information (CSI) report on the DL channel status, and a scheduling request (SR). The remaining symbols may be used for DL data transmission (e.g. physical downlink shared channel (PDSCH)) or for UL data transmission (e.g. physical uplink shared channel (PUSCH)).

According to this subframe structure, DL transmission and UL transmission may sequentially proceed in one subframe. Accordingly, DL data may be transmitted in the subframe, and UL acknowledgement/non-acknowledgement (ACK/NACK) may also be received in the subframe. In this manner, the subframe shown in FIG. 4 may be referred to as self-contained subframe. As a result, it may take less time to retransmit data when a data transmission error occurs, thereby minimizing the latency of final data transmission. In the self-contained subframe structure, a time gap may be required for the transition process from the transmission mode to the reception mode or from the reception mode to the transmission mode. For this purpose, some OFDM symbols at the time of switching from DL to UL in the subframe structure may be set to the guard period (GP).

In order to reduce latency, short TTI (sTTI) which may be shorter than current TTI (i.e. 1 ms) has been considered. For example, length of sTTI may be one of 1/2/3/4/7 symbols. When a sTTI is introduced for latency reduction in LTE, E-UTRAN may be configured with both normal TTI with 1 ms and sTTI with a value less than 1 ms, such as 2 symbols or 0.5 ms. With keeping the current LTE frame structure, OFDM symbol length, subcarrier spacing, etc., reduction of TTI generally means smaller transport block size (TBS) contained in one TTI, and relatively larger control overhead if DCI size is kept as the same. The sTTI may be achieved by increasing or changing subcarrier spacing.

When sTTI is adopted, and as a result, the number of OFDM symbols is reduced in one TTI (e.g. from 14 to 2) or subcarrier spacing increases (e.g. from 15 kHz to 60 kHz), a RB size may be different from the current RB size. For example, with subcarrier spacing of 60 kHz, one RB may include 12×8 resource elements, instead of 12×14 resource elements. For another example, when TTI length is 2 OFDM symbol length, one RB may include 12×2 resource elements. If sTTI is used, particularly with smaller number of OFDM symbols, larger RB size in frequency domain may be considered (e.g. one RB includes 48×2 resource elements). To be aligned in terms of total RE per PRB or resource unit, two 6 PRBs may be considered as a resource unit for 2 OFDM symbols sTTI case.

Hereinafter, the present invention provides a method for handling different sTTIs configured dynamically. Different combinations of sTTI length may be considered. In general, there may be two or more set of sTTI lengths in DL and UL, separately. For example, it is assumed that M1, M2 and M3 may be configured as length of sTTIs, and M2=k1*M1, and M3=k2*M2. In other words, within one M3, multiple of M2 may be placed, and within one M2, multiple of M1 may be placed. For example, M3 may be 14 OFDM symbols. M2 may be 7 OFDM symbols.

Accordingly, within one M3, 2*M2 may be placed. M1 may be 2 OFDM symbols. Accordingly, within one M2, variation of 2*M1+3 OFDM symbols may be placed.

When different sTTI length is configured between DL and UL, the timing may follow one of the followings.
For DL control to PDSCH, configured sTTI length for DL may be applied.
For PUCCH for ACK/NACK transmission, configured sTTI length for DL may be applied.
For PUSCH transmission, configured sTTI length for UL may be applied.

To align different channel transmission in UL, sTTI length for UL channel may be indicated dynamically in DL scheduling assignment and UL grant, respectively.

The set of configured sTTI length for DL and/or UL may be configured, instead of allowing all the possible sTTI length. This is particularly important when there are multiple numerologies supported by the UE/network and possible sTTI lengths based on numerology may be configured per UE and/or per cell.

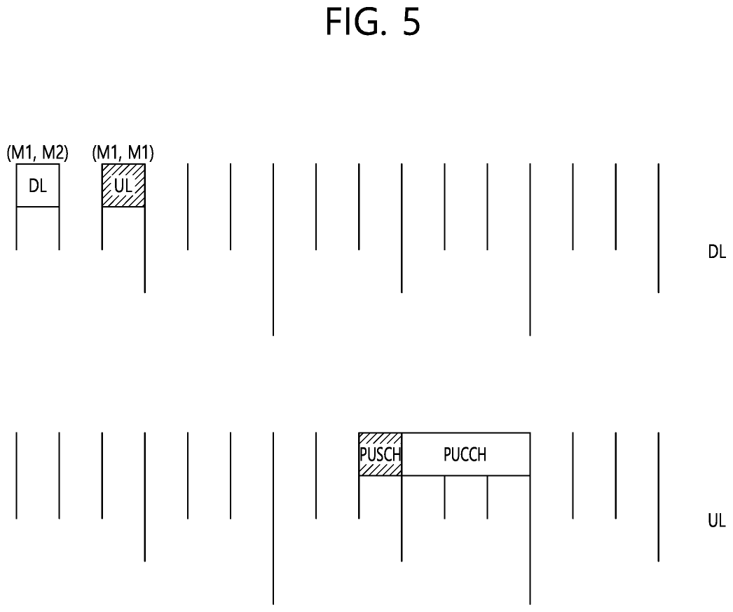

FIG. 5 shows an example of configuring sTTI length for DL and/or UL according to an embodiment of the present invention. Referring to FIG. 5, a network schedules DL at (M1, M2) and (M1, M1) in different sTTI of M1. That is, DL scheduling assignment is scheduled based on M1 sTTI, and PUCCH transmission as a response to the DL scheduling assignment is scheduled based on M2 sTTI. Further, a network schedules UL at (M1, M1) in different sTTI of M1. That is, UL grant is scheduled based on M1 sTTI, and PUSCH transmission as a response to the UL grant is scheduled based on M1 sTTI. In this case, any scheduling combination may be supported in anytime.

Also, if UL grant is scheduled on sTTI later, it may collide with PUCCH. Due to different timing of M1 and M2, if M1 and M2 are indicated by M1 sTTI for DL, the same sTTI length for UL may be expected per M3 sTTI or at least per M2 sTTI. In other words, any scheduling of M1, M2 and M1, M1 between DL and UL grant may be mixed within M2, and the same size of UL sTTI may be expected within M2 sTTI or M3 sTTI. Overall, if DL sTTI length can be changed, the maximum sTTI length or TTI length should be used and the same sTTI length may be assumed for both DL and UL. In other words, the same size of sTTI for DL and UL may be assumed within one M3 sTTI. It may change the size in different M3 sTTI. More generally, the set of points where different DL and/or UL sTTI length can be indicated may be configured as well. If slow DCI or two-level DCI is used, this type of information may be delivered via slow DCI, along with potentially numerology information.

For different channel, the constraints may not be present as long as they are not overlapping partially or fully at the same time resource. The constraints may be applied only to the same UL channel (e.g. between HARQ-ACK or between PUSCHs). If this is too restrictive, another approach is to consider the same sTTI length between the same UL channels if they are indicated from the same size of sTTI DL length. In other words, M1 sTTI length for DL schedules two different M1/M2 sTTI length for UL, from the M1 sTTI length for DL, the same size of sPUSCH or sPUCCH may be assumed within one subframe or within M3 sTTI or M2 sTTI. Alternatively, no restriction may be imposed and fully dynamic length of channels may be assumed. If this is supported, some handling of colliding ACK/NACK resources between different DL sTTI length may also be necessary.

Even with constraints, it may be possible that, due to different timing, sPUSCH with M1 sTTI scheduled later may need to be transmitted earlier than sPUSCH with M2 sTTI scheduled earlier. When they collide with each other, whether to follow UL grant timing to determine which one is earlier or follow actual PUSCH timing to determine which one is earlier needs to be clarified where both options may be considered.

When different sTTI may be dynamically indicated, ACK/NACK bundling or multiplexing or multiple ACK/NACK on the same resource needs to be clarified. The ACK/NACK resource determination may follow the scheduled information, namely, i.e. following DL/UL sTTI length indicated dynamically. For semi-static transmission such as SPS, the ACK/NACK resource determination may follow the sTTI configured for SPS configuration for ACK/NACK timing. Multiplexing of such SPS may also be done based on the configured timing of SPS. When simultaneous sPUSCH/sPUCCH transmission is configured, the UE may transmit sPUCCH/sPUSCH simultaneously if the indicted sTTI length for both are equal. Otherwise, it may follow the rule to drop either one based on the priority.

If multiple ACK/NACK can be bundled in one PUCCH or one ACK/NACK resource, the total DAI may need to be indicated independently per each ACK/NACK resource or sTTI PUCCH length. To address different DL sTTI length and different timing, it may be necessary to indicate separate total DAI per DL, PUCCH sTTI length pair (i.e. per each pair of DL sTTI length and ACK/NACK sTTI length). When total DAIs from two different DL sTTI length overlaps from each other with the same ACK/NACK resource, the sum of total DAI with different DL sTTI may be additionally necessary to avoid any ambiguity. Alternatively, maximum codebook sizes which includes both or all sTTI lengths for DL, which may be mapped to one sTTI of ACK/NACK resource, may always be used to avoid any ambiguity. It is noted that sTTI PUCCH length is the granularity of ACK/NACK resource occasions, not the duration of PUCCH or ACK/NACK resource. Different duration of sPUCCH may be indicated within the same sTTI PUCCH length.

If dynamic sTTI length is considered with certain restriction as mentioned above, it may also be necessary to support dynamic switching of sTTI length between initial and retransmission, as there may be no opportunities of the same sTTI length in a given subframe or time duration for retransmission. In this case, transmission of redundancy version (RV) may become challenging, particularly when TTI becomes shorter in retransmission. To address this issue, one approach may be to configure finer granularity of RV defined within one RV constructed for initial transmission. For example, if four RVs are configured for M3 based initial transmission, per each RV, k1*k2 finer RVs may be configured, which may also be dynamically indicated by DCI. Alternatively, the same RV may be used regardless of sTTI length, and only partial data may be transmitted when retransmission occurs in a smaller sTTI length compared to initial transmission.

When semi-static UL transmissions are configured based on a certain set of sTTI length, in the same slot where semi-static configuration is assumed, a UE expects to be indicated with the same sTTI length indicated dynamically. If different sTTI length is configured, then a UE may drop semi-statically configured transmission. Alternative approach is to configure different set of resources per different sTTI length, and a UE may follow dynamically indicated sTTI length for resource selection if any. Otherwise, the smallest sTTI length may be used for the semi-static transmission.

If different ACK/NACK timing is also indicated by DCI, the timing may also be dependent on the sTTI length used for DL or UL transmission. For ACK/NACK timing, it may follow DL sTTI length based on the configured sTTI length or dynamically indicated DL sTTI length. For UCI piggybacking, when different sTTI UL channels are colliding, shorter channels may be assumed for higher priority channel.

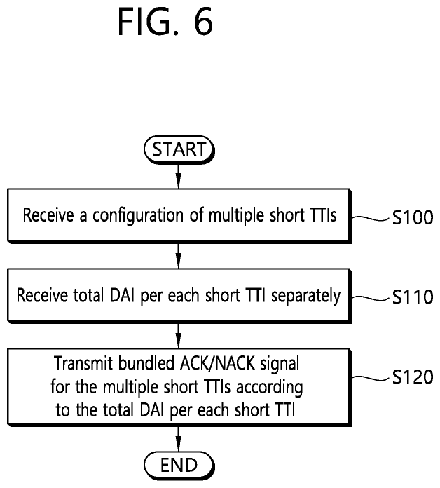

FIG. 6 shows a method for transmitting an ACK/NACK signal by a UE according to an embodiment of the present invention. The present invention described above may be applied to this embodiment of the present invention.

In step S100, the UE receives, from a network, a configuration of multiple sTTIs. In step S110, the UE receives, from the network, a total downlink DAI per each sTTI separately. In step S120, the UE transmits, to the network, a bundled ACK/NACK signal for the multiple sTTIs according to the total DAI per each sTTI.

The multiple sTTIs may have different lengths from each other. The bundled ACK/NACK signal for the multiple short TTIs may be transmitted in one PUCCH resource or in one ACK/NACK resource. The one PUCCH resource or the one ACK/NACK resource may be determined based on the configuration of the multiple sTTIs.

Furthermore, the total DAI for the multiple sTTIs may overlap with each other with the same ACK/NACK resource. In this case, the UE may receive, from the network, a sum of total DAIs for the multiple sTTIs.

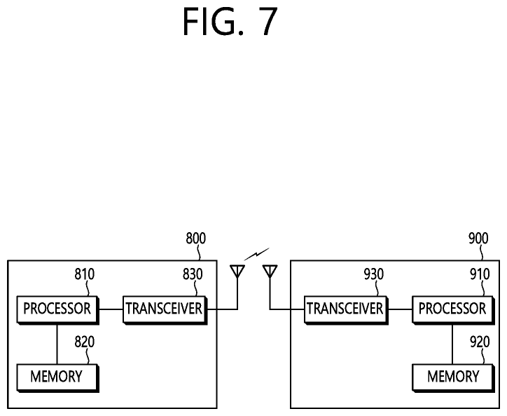

FIG. 7 shows a wireless communication system to implement an embodiment of the present invention.

A network node 800 includes a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 includes a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What is claimed is:

1. A method for transmitting an acknowledgement/non-acknowledgement (ACK/NACK) signal by a user equipment (UE) in a wireless communication system, the method comprising:
receiving, by the UE from a network, a configuration of multiple short transmission time intervals (TTIs);
receiving, by the UE from the network, a total downlink assignment index (DAI) per each short TTI separately; and
transmitting, by the UE to the network, a bundled ACK/NACK signal for the multiple short TTIs according to the total DAI per each short TTI.

2. The method of claim 1, wherein the multiple short TTIs have different lengths from each other.

3. The method of claim 1, wherein the bundled ACK/NACK signal for the multiple short TTIs is transmitted in one physical uplink control channel (PUCCH) resource or in one ACK/NACK resource.

4. The method of claim 3, wherein the one PUCCH resource or the one ACK/NACK resource is determined based on the configuration of the multiple short TTIs.

5. The method of claim 1, wherein the total DAI for the multiple short TTIs overlaps with each other with the same ACK/NACK resource.

6. The method of claim 5, further comprising receiving, by the UE from the network, a sum of total DAIs for the multiple short TTIs.

7. A user equipment (UE) in a wireless communication system, the UE comprising:
a memory;
a transceiver; and
a processor, operably coupled to the memory and the transceiver, that:
controls the transceiver to receive, from a network, a configuration of multiple short transmission time intervals (TTIs),
controls the transceiver to receive, from the network, a total downlink assignment index (DAI) per each short TTI separately, and
controls the transceiver to transmit, to the network, a bundled acknowledgement/non-acknowledgement (ACK/NACK) signal for the multiple short TTIs according to the total DAI per each short TTI.

8. The UE of claim 7, wherein the multiple short TTIs have different lengths from each other.

9. The UE of claim 7, wherein the bundled ACK/NACK signal for the multiple short TTIs is transmitted in one physical uplink control channel (PUCCH) resource or in one ACK/NACK resource.

10. The method of claim 9, wherein the one PUCCH resource or the one ACK/NACK resource is determined based on the configuration of the multiple short TTIs.

11. The UE of claim 7, wherein the total DAI for the multiple short TTIs overlaps with each other with the same ACK/NACK resource.

12. The UE of claim 11, wherein the processor controls the transceiver to receive, from the network, a sum of total DAIs for the multiple short TTIs.
